(19) United States
(12) Patent Application Publication
(10) Pub. No.: US 2025/0205118 A1
(43) Pub. Date: Jun. 26, 2025

(54) Pacifying personal protective device and a detachable pacifier arrangement

(71) Applicant: Toni Jefferson, Jackson, TN (US)

(72) Inventor: Toni Jefferson, Jackson, TN (US)

(21) Appl. No.: 18/392,977

(22) Filed: Dec. 21, 2023

(51) Int. Cl. A61J 17/00

(52) U.S. Cl. CPC A61J 17/113; A61J 17/001; A61J 17/1115

(57) ABSTRACT

A detachable pacifier arrangement includes a nipple portion and a handle portion detachably connected to one another by a child-proof securing arrangement. The nipple portion is designed to be sucked on by a child. The handle portion is designed to be connected to said nipple portion and grasped by a child or an adult. The child-proof securing arrangement is designed to detachably connect the nipple portion to the handle portion to releasably clamp the nipple portion and the handle portion together onto opposing sides of a panel of an object to be placed near a mouth of a child.

### CROSS-REFERENCE TO RELATED APPLICATIONS

This application is a Continuation-in-part of co-pending U.S. patent application Ser. No. 17/488,525, filed Sep. 29, 2021, which application is incorporated by reference as if set forth in its entirety herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to personal protective devices and more particularly pertains to a new personal protective device for a child. The present invention discloses a personal protective device comprising a panel configured for engaging a head of a child, wherein the panel has a detachable pacifier arrangement temporarily connected thereto. The present invention also discloses a detachable pacifier arrangement designed to be removably attached to an object, such as a protective face covering, blanket, or other such object for infants and toddlers.

### (2) Description of Related Art Including Information Disclosed under 37 CFR 1.97 and 1.98

The prior art relates to personal protective devices. Prior art personal protective devices may comprise facial masks with integral nipples or pacifiers, and facial masks with insertion holes. As best understood, the prior art does not disclose a detachable pacifier arrangement designed to be removably attached to an object, such as a protective face covering, blanket, or other such object for infants and toddlers.

### BRIEF SUMMARY OF THE INVENTION

An embodiment of the disclosure meets the needs presented above in a detachable pacifier arrangement generally comprising a nipple portion and a handle portion detachably connected to one another by a child-proof securing arrangement. The nipple portion is designed to be sucked on by a child. The handle portion is designed to be connected to said nipple portion and grasped by a child or an adult. The child-proof securing arrangement is designed to detachably connect the nipple portion to the handle portion to releasably clamp the nipple portion and the handle portion together onto opposing sides of a panel of an object to be placed near a mouth of a child. The child-proof securing arrangement could comprise a locking-pin style connection, such as those used for retail security tags for clothing, a magnetic connection, or a snap-fit connection, or similar connections, provided that the connection is sufficiently strong and/or inaccessible to the child such that only an adult or teenaged person can disconnect the child-proof securing arrangement and the child reasonably cannot accidentally or intentionally do so.

In accordance with one possible embodiment, a pacifying personal protective device includes the detachable pacifier arrangement in combination with a panel, which is configured to be attached to a head of a child so that the panel is positioned over at least a mouth and a nose of the child. The panel is configured to reduce transmission of pathogens between the child and persons proximate to the child. The detachable pacifier arrangement is engaged to the panel and is positioned proximate to the mouth of the child. The detachable pacifier arrangement is configured to facilitate pacification of the child, thus increasing a likelihood that the panel will remain in position on the head of the child. The detachable pacifier arrangement is designed to be used with panels or portions of different objects that may be placed near the mouth of a child, such as a protective mask, blanket, or other such object for infants and toddlers. Such objects may comprise a material, such as a cloth or fabric, that may be easily penetrated or are sufficiently thin and/or flexible or deformable to permit attachment and detachment of the detachable pacifier arrangement to and from the object. The objects may also comprise an aperture therein to permit attachment and detachment of the detachable pacifier arrangement to and from the object.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear perspective view of a pacifying personal protective device according to an embodiment of the disclosure.

FIG. 2 is a rear view of an embodiment of the disclosure.

FIG. 3 is a front view of an embodiment of the disclosure.

FIG. 4 is a cross-sectional view of an embodiment of the disclosure.

FIG. 5 is a cross-sectional view of an embodiment of the disclosure.

FIG. 6 is a perspective view of an embodiment of the disclosure.

FIG. 7 is a cross-sectional view of an embodiment of the disclosure.

FIG. 8 is a cross-sectional view of an embodiment of the disclosure.

FIG. 9 is a rear perspective view of an embodiment of the disclosure.

FIG. 10 is a cross-sectional view of an embodiment of the disclosure.

FIG. 11 is a cross-sectional view of an embodiment of the disclosure.

FIG. 12 is a cross-sectional view of an embodiment of the disclosure.

### DETAILED DESCRIPTION OF THE INVENTION

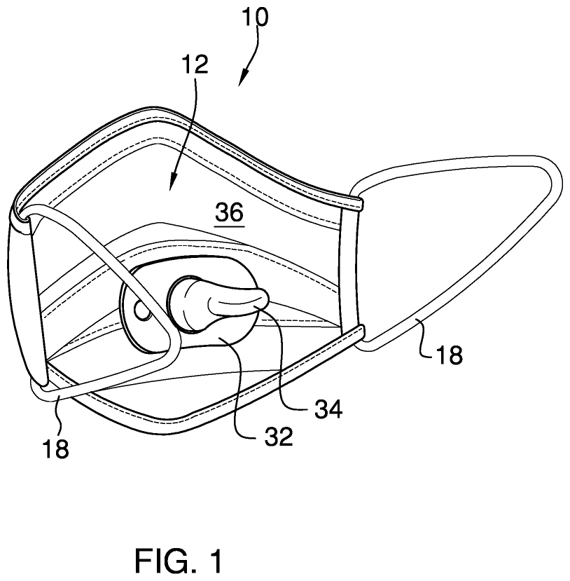

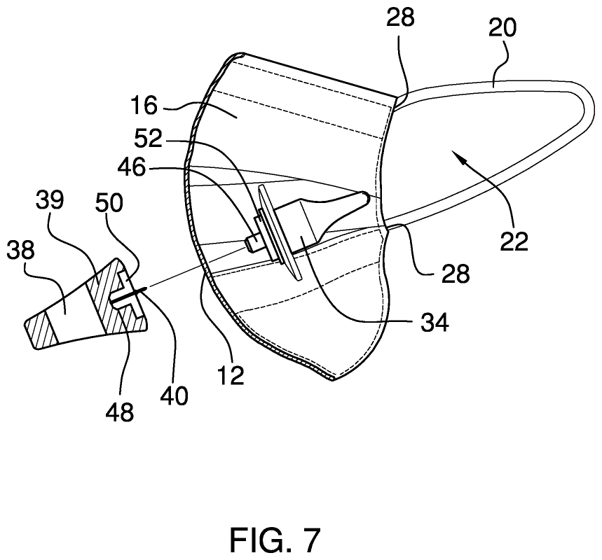

With reference now to the drawings, and in particular to FIGS. 1 through 12 thereof, a new personal protective device embodying the principles and concepts of an embodiment of the disclosure and generally designated by the reference numeral 10 will be described.

As best illustrated in FIGS. 1 through 12, the pacifying personal protective device 10 generally comprises a panel 12, which is configured to be attached to a head of a child so that the panel 12 is positioned over at least a mouth and a nose of the child. The panel 12 is configured to reduce transmission of pathogens between the child and persons proximate to the child. The panel 12 may comprise a face shield 14, a mask 16, or the like.

A fastener 18 is engaged to the panel 12 and is configured to selectively engage the head of the child so that the panel 12 is removably engaged to the head of the child and positioned over at least the mouth and the nose of the child. The fastener 18 may comprise a set of bands 20, or other fastening means, such as, but not limited to, straps, ties, and the like. The bands 20 comprise elastic and thus are resiliently stretchable. Each band 20 defines a loop 22, which is configured to be positioned around a head or a respective ear of the child to removably engage the panel 12 to the head of the child.

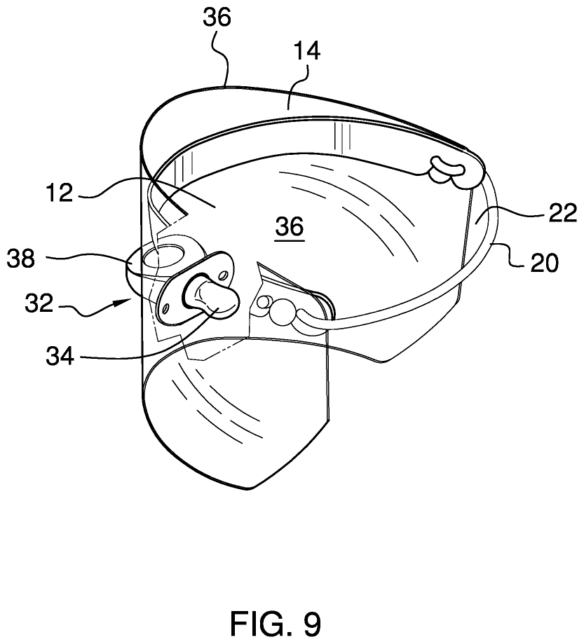

As shown in FIG. 9, wherein the panel 12 comprises a face shield 14, the set of bands 20 comprises one band 20 engaged to and extending between opposed side edges 24 of the face shield 14 proximate to an upper rim 26 of the face shield 14. The band 20 is configured to be stretched to position the head of the child between the band 20 and the upper rim 26 so that the face shield 14 is frictionally engaged to the head of the child upon rebounding of the band 20.

As shown in FIGS. 1-4 and 7-8, wherein the panel 12 comprises a mask 16, the set of bands 20 comprises two bands 20. Each band 20 has opposed ends 28 engaged to a respective opposing side 30 of the mask 16 defining a loop 22. The band 20 is configured to be stretched to position a respective ear of the child into the loop 22 so that the mask 16 is engaged to the head of the child upon rebounding of the band 20.

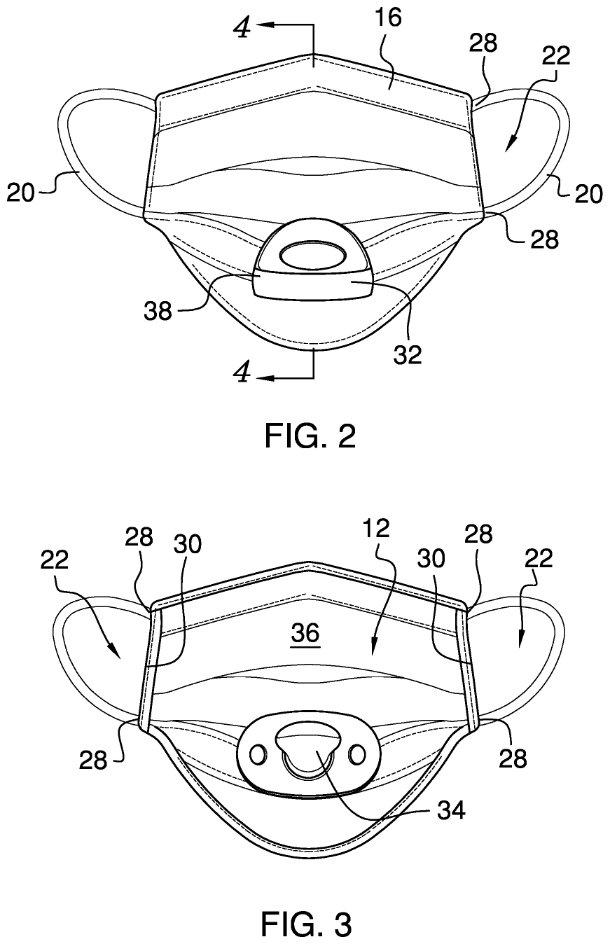

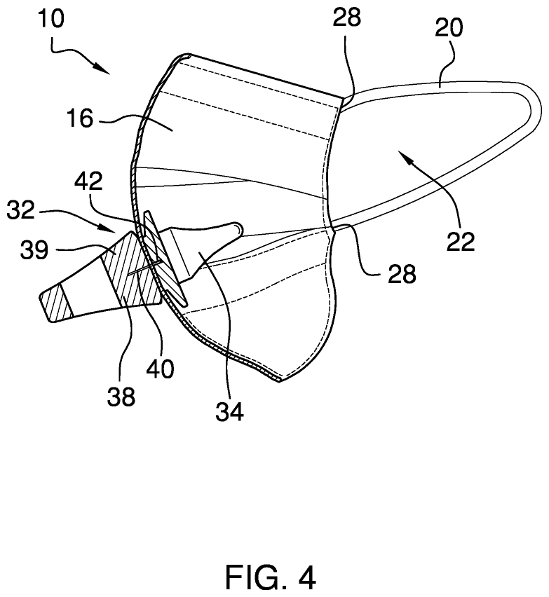

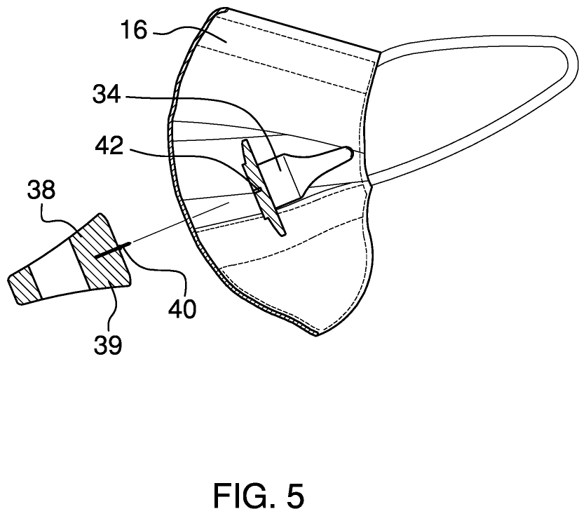

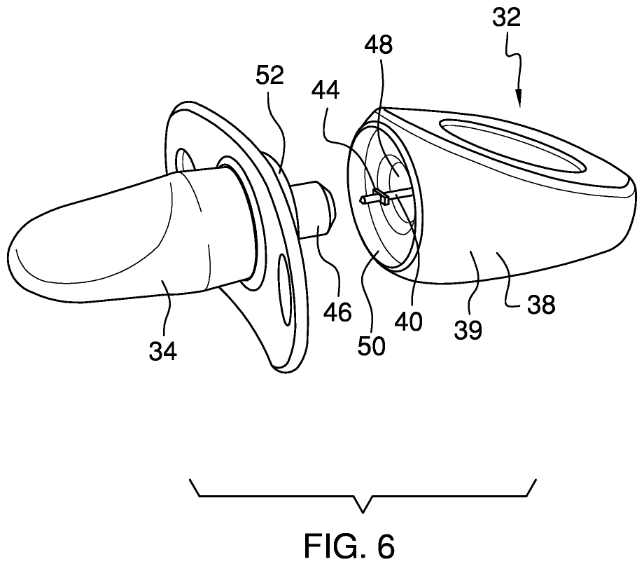

As seen in FIG. 1, a detachable pacifying arrangement 32 is engaged to the panel 12 and is to be positioned proximate to the mouth of the child. The detachable pacifying arrangement 32 is configured to facilitate pacification of the child, thus increasing a likelihood that the panel 12 will remain in position on the head of the child. As seen in FIG. 3, the detachable pacifying arrangement 32 includes a nipple portion 34 configured to be sucked on by a child. As seen in FIG. 2, the detachable pacifier arrangement 32 also includes a handle portion 38 configured to be connected to the nipple portion 34 and grasped by a child or an adult. The handle portion 38 and the nipple portion 34 are configured to be connected by a child-proof securing arrangement, as further disclosed herein. FIG. 4 shows a cross-section of at least one embodiment along the view referenced in FIG. 2. As shown in FIG. 4, in accordance with at least one embodiment, the handle portion 38 includes a body 39 and a securing pin 40 disposed partially in and to project out beyond the body 39. The nipple portion 34 includes a pin receptacle 42 configured and disposed to receive and engage with the securing pin 40 in a releasable, locking manner. The securing pin 40 is configured to be releasably locked with the pin receptacle 42 to releasably clamp the nipple portion 34 and the handle portion 38 together onto opposing sides of the mask 16. In this manner the detachable pacifier arrangement 32 may be securely attached to the mask 16 such that it essentially cannot be removed by a child, but can be easily removed by an adult, such as for cleaning, replacement, or positioning on another object. FIG. 5 shows the nipple portion 34 and the handle portion 38 separated from one another either before attachment onto the mask 16 or after detachment from the mask 16. In accordance with at least one possible embodiment, the securing pin 40 comprises a crosspiece 44 configured to engage with the pin receptacle 42 in a releasable, locking manner. In this embodiment, the securing pin 40 can be inserted into the pin receptacle 42 and then turned like a key in a lock with the crosspiece 44 acting as a retaining flange inside the pin receptacle 42. The crosspiece 44 is best seen in FIG. 6.

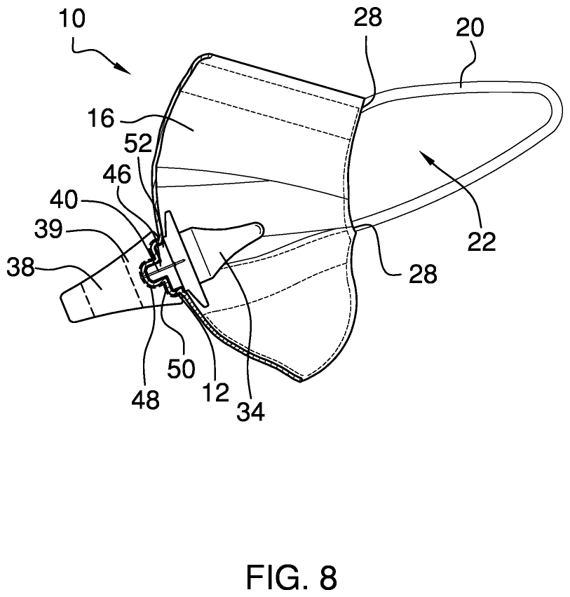

FIG. 6 shows solely the detachable pacifier arrangement 32 in accordance with an alternative possible embodiment, wherein the nipple portion 34 comprises a shoulder 52 disposed about the pin receptacle 42. The handle portion 38 comprises a recess 50 disposed about the securing pin 40 and configured to receive the shoulder 52 in a form fit or friction fit to further secure the nipple portion 34 and the handle portion 38 together on the mask 16. As seen in FIG. 8, the shoulder 52 and the recess 50 are configured and disposed to clamp and temporarily deform the mask 16. In other words, the cloth or fabric of the mask 16 is clamped or held between the shoulder 52 and the recess 50. This allows placement of the detachable pacifier arrangement 32 on any cloth or fabric mask 16 at any location on the mask 16. In addition, the pin receptacle 42 comprises a projection 46 disposed to project out from the shoulder 52. The handle portion 38 comprises a projection receptacle 48 disposed about the securing pin 49 and configured to receive the projection 46 in a form fit or friction fit to further secure the nipple portion 34 and the handle portion 38 together on the mask 16. The projection 46 and the projection receptacle 48 are configured and disposed to clamp the mask 16 in a similar manner.

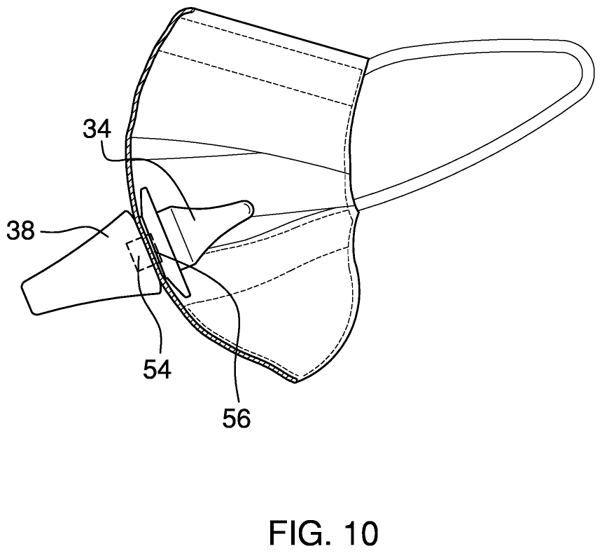

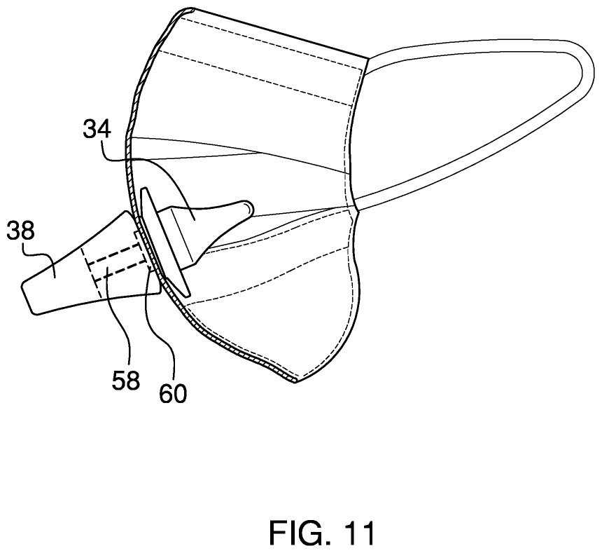

As shown in FIG. 10, the child-proof securing arrangement comprises a first magnetic structure 54 and a second magnetic structure 56, which provide a magnetic connecting or clamping force sufficient to detachably clamp the nipple portion 34 and the handle portion 38 together in a secure, child-proof manner. FIG. 11 shows another embodiment of the child-proof securing arrangement wherein the handle portion 38 comprises a locking tab 48 and the nipple portion 34 comprises a snap-fit receptacle 60. The locking tab 48 can be inserted in a snap-fit manner into the snap-fit receptacle 60 to detachably clamp the nipple portion 34 and the handle portion 38 together in a secure, child-proof manner. To release the connection, an adult can depress the locking tab 48 and disconnect the handle portion 38 from the nipple portion 34. The locking tab 48 should be configured to be sufficiently strong and resistant to depression such that a child could not accidentally or intentionally depress the locking tab 48 and disconnect the handle portion 38 from the nipple portion 34.

Any embodiment of the detachable pacifier arrangement 32 can be used in combination with a protective face covering to form a pacifying personal protective device 10 configured to be positioned over at least a mouth and a nose of a child to reduce transmission of pathogens between the child and persons proximate to the child. If the panel 12 is a plastic part of a face shield 14, such as shown in FIG. 9, the face shield 14 comprises an aperture (not shown) therein having a diameter similar to the outer diameter of the shoulder 52 to permit removable attachment of the detachable pacifier arrangement 32 to the face shield 14 with the nipple portion 34 disposed on the interior of the face shield 14 and the handle portion 38 disposed on the exterior of the face shield 14. If the panel 12 is a cloth or fabric portion of the mask 16, as shown in FIGS. 1-5 and 7-8, the mask 16 can comprise an aperture (not shown) therein having a diameter similar to the outer diameter of the shoulder 52 to permit removable attachment of the detachable pacifier arrangement 32 to the mask 16 with the nipple portion 34 disposed on the interior of the mask and the handle portion 38 disposed on the exterior of the mask.

In accordance with at least one possible embodiment, the detachable pacifier arrangement 32 is attachable to any cloth or fabric mask 16, even those without an aperture therein. Specifically, the securing pin 40 is configured to be inserted into and through the mask and into the pin receptacle 42. In other words, the securing pin can penetrate or puncture the cloth or fabric. This promotes secure connection and positioning in any location on the mask 16.

In use, the pacifying personal protective device 10 enables a pathogen transmission reduction and child pacification method. The nipple 34 is engaged to and extends from an inner surface 36 of the panel 12. By positioning the nipple 34 in a position adjacent the mouth of the child, the nipple 34 can be sucked upon by the child to pacify the child.

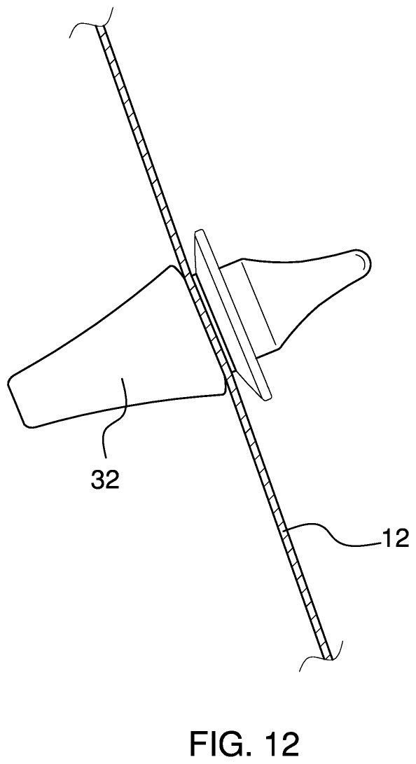

FIG. 12 shows an alternative use of the detachable pacifier arrangement 32, wherein the panel 12 could also comprise most any structure to be placed near the face of a child, such as a blanket or towel. It should be understood that any of the embodiments of the detachable pacifier arrangement 32 disclosed herein may be used as part of a pacifying personal protective device 10 or alternatively as simply a pacifier that may be attached to most any cloth or fabric or similar object that may be placed near the face of a child.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A detachable pacifier arrangement comprising:
a nipple portion being configured to be sucked on by a child;
a handle portion being configured to be connected to said nipple portion and grasped by a child or an adult; and
a child-proof securing arrangement being configured and disposed to detachably connect said nipple portion to said handle portion to releasably clamp said nipple portion and said handle portion together onto opposing sides of a panel of an object to be placed near a mouth of a child.

2. The detachable pacifier arrangement of claim 1, wherein:
said child-proof securing arrangement comprises a securing pin disposed partially in and to project out beyond said handle portion;
said child-proof securing arrangement comprises a pin receptacle disposed in said nipple portion and configured and disposed to receive and engage with said securing pin in a releasable, locking manner; and
said securing pin is configured to be releasably locked with said pin receptacle.

3. The detachable pacifier arrangement of claim 2, wherein said securing pin comprises a crosspiece configured to engage with said pin receptacle in a releasable, locking manner.

4. The detachable pacifier arrangement of claim 3, wherein:
said nipple portion comprises a shoulder disposed about said pin receptacle;
said handle portion comprises a recess disposed about said securing pin and configured to receive said shoulder in a form fit or friction fit to further secure said nipple portion and said handle portion together on a panel of an object to be placed near a mouth of a child; and
said shoulder and said recess are configured and disposed to clamp and temporarily deform the panel of the object to be placed near a mouth of a child therebetween.

5. The detachable pacifier arrangement of claim 4, wherein:
said receptacle comprises a projection disposed to project out from said shoulder;
said handle portion comprises a projection receptacle disposed about said securing pin and configured to receive said projection in a form fit or friction fit to further secure said nipple portion and said handle portion together on a panel of an object to be placed near a mouth of a child; and
said projection and said projection receptacle are configured and disposed to clamp and temporarily deform the panel of the object to be placed near a mouth of a child therebetween.

6. The detachable pacifier arrangement of claim 2, wherein:
said nipple portion comprises a shoulder disposed about said pin receptacle;
said handle portion comprises a recess disposed about said securing pin and configured to receive said shoulder in a form fit or friction fit to further secure said nipple portion and said handle portion together on a panel of an object to be placed near a mouth of a child; and
said shoulder and said recess are configured and disposed to clamp and temporarily deform the panel of the object to be placed near a mouth of a child therebetween.

7. The detachable pacifier arrangement of claim 6, wherein:
said pin receptacle comprises a projection disposed to project out from said shoulder;
said handle portion comprises a projection receptacle disposed about said securing pin and configured to receive said projection in a form fit or friction fit to further secure said nipple portion and said handle portion together on a panel of an object to be placed near a mouth of a child; and
said projection and said projection receptacle are configured and disposed to clamp and temporarily deform the panel of the object to be placed near a mouth of a child therebetween.

8. The detachable pacifier arrangement of claim 5, in combination with a protective face covering to form a pacifying personal protective device, which protective face covering comprises a panel configured to be positioned over at least a mouth and a nose of a child to reduce transmission of pathogens between the child and persons proximate to the child.

9. The detachable pacifier arrangement in combination with said protective face covering of claim 8, wherein said protective face covering comprises a fastener engaged to said panel and configured to removably engage said panel to a head of a child in a position over at least the mouth and the nose of the child.

10. The detachable pacifier arrangement in combination with said protective face covering of claim 9, wherein:
said panel comprises a face shield made of plastic; and
said face shield comprises an aperture therein having a diameter similar to the outer diameter of said shoulder to permit removable attachment of said detachable pacifier arrangement to said face shield with said nipple portion disposed on the interior of said face shield and said handle portion disposed on the exterior of said face shield.

11. The detachable pacifier arrangement in combination with said protective face covering of claim 9, wherein:
said panel comprises a mask made of cloth or fabric; and
said mask comprises an aperture therein having a diameter similar to the outer diameter of said shoulder to permit removable attachment of said detachable pacifier arrangement to said mask with said nipple portion disposed on the interior of said mask and said handle portion disposed on the exterior of said mask.

12. The detachable pacifier arrangement of claim 3, in combination with a protective face covering to form a pacifying personal protective device, which protective face covering comprises a panel configured to be positioned over at least a mouth and a nose of a child to reduce transmission of pathogens between the child and persons proximate to the child.

13. The detachable pacifier arrangement in combination with said protective face covering of claim 12, wherein:
said panel comprises a mask made of cloth or fabric; and
said securing pin is configured to be inserted into and through the mask and into said pin receptacle.

14. The detachable pacifier arrangement of claim 6, in combination with a protective face covering to form a pacifying personal protective device, which protective face covering comprises a panel configured to be positioned over at least a mouth and a nose of a child to reduce transmission of pathogens between the child and persons proximate to the child.

15. The detachable pacifier arrangement in combination with said protective face covering of claim 14, wherein:
said panel comprises a mask made of cloth or fabric; and
said securing pin is configured to be inserted into and through the cloth or fabric and into said pin receptacle.

16. The detachable pacifier arrangement of claim 7, in combination with a protective face covering to form a pacifying personal protective device, which protective face covering comprises a panel configured to be positioned over at least a mouth and a nose of a child to reduce transmission of pathogens between the child and persons proximate to the child.

17. The detachable pacifier arrangement in combination with said protective face covering of claim 16, wherein:
said panel comprises a mask made of cloth or fabric; and
said securing pin is configured to be inserted into and through the cloth or fabric and into said pin receptacle.

18. The detachable pacifier arrangement of claim 1, wherein:
said child-proof securing arrangement comprises a first magnetic structure disposed in said handle portion;
said child-proof securing arrangement comprises a second magnetic structure disposed in said nipple portion; and
said first magnetic structure and said second magnetic structure are configured to provide a magnetic connecting or clamping force sufficient to detachably clamp said nipple portion and said handle portion together in a secure, child-proof manner.

19. The detachable pacifier arrangement of claim 1, wherein:
said child-proof securing arrangement comprises a locking tab disposed in said handle portion;
said child-proof securing arrangement comprises a snap-fit receptacle disposed in said nipple portion; and
said locking tab is configured to be inserted in a snap-fit manner into the snap-fit receptacle to detachably clamp said nipple portion and said handle portion together in a secure, child-proof manner.
